(19) United States
(12) Patent Application Publication
(10) Pub. No.: US 2002/0060777 A1
(43) Pub. Date: May 23, 2002

(54) METHOD OF FORMING COLORED CONTACT LENS HAVING VERY NATURAL APPEARANCE AND PRODUCT MADE THEREBY

(76) Inventors: L. LAWRENCE CHAPOY, BARRINGTON, IL (US); RICHARD L. JAHNKE, VILLA PARK, IL (US)

Correspondence Address: BRINKS HOFER GILSON & LIONE, P.O. BOX 10395, CHICAGO, IL, 60610, US

(21) Appl. No.: 08/770,251

(22) Filed: Dec. 20, 1996

Related U.S. Application Data
(63) Continuation-in-part of application No. 08/419,882, filed on Apr. 11, 1995.
Application No. 08/419,882 is a continuation of application No. 07/984,817, filed on Dec. 3, 1992.
Application No. 07/984,817 is a continuation of application No. 07/704,260, filed on May 22, 1991, now abandoned.
Application No. 07/704,260 is a continuation of application No. 07/430,222, filed on Nov. 1, 1989, now abandoned.

(51) Int. Cl. G02C 7/04

(52) U.S. Cl. 351/162; 351/160 R

(57) ABSTRACT

A method of forming a contact lens containing a colored ring that covers a portion of or the entire limbus area of the eye when the contact lens is worn. The method of forming the contact lens includes applying a colorant material in a limbal ring pattern to the surface of a one-sided contact lens mold, then filling the one-sided contact lens mold with a polymerizable substance, casting the substance thereby forming a molded surface containing a limbal ring pattern, and machining the opposite side thereby creating a finished side opposite the molded surface.

This application is a continuation-in-part of U.S. application Ser. No. 08/419,882, filed Apr. 11, 1995, which is a continuation of U.S. application Ser. No. 07/984,817, filed Dec. 3, 1992, now U.S. Pat. No. 5,414,477, which is a continuation of U.S. application Ser. No. 07/704,260, filed May 22, 1991, now abandoned, which is a continuation of U.S. application Ser. No. 07/430,222, filed Nov. 1, 1989, now abandoned.

This application incorporates by reference the entire specification of U.S. application Ser. No. 08/419,882, and ipso facto Ser. Nos. 07/984,817 (now U.S. Pat. No. 5,414,477), 07/704,260, and 07/430,222.

### SUMMARY OF THE INVENTION

The present invention relates generally to a method of forming a colored contact lens having an opaque colored portion that provides a cosmetic improvement to the wearer's eye while imparting a very natural appearance. In particular, the present invention relates to a method of forming a contact lens containing a colored ring which covers a portion of or the entire limbus area of the eye when the contact is worn, thereby improving the wearer's appearance.

The limbus area is the area of the eye located between the iris area and the sclera area. The limbus area is usually darker in color than the iris area, especially on light colored eyes, and as a person begins to age or becomes sick, the limbus area can lighten in color or begin to cloud. A darker limbal area therefore provides an enhanced appearance. A contact lens containing a limbal ring increases the contrast at the limbus and provides better definition at the junction of the iris and sclera. The limbal ring may be of constant or variable thickness and may be composed either of solid colorant or an intermittent array of colorant elements. Examples of limbal rings utilized on contact lenses are described in U.S. Pat. No. 5,414,477 to Jahnke, and U.S. Pat. Nos. 5,160,463 and 5,302,978 to Evans.

In the present form of the invention, the process of forming a contact lens containing a colored ring around the limbus area is accomplished by first printing a colorant onto the surface of a one-sided contact lens mold. The colorant is positioned such that it will cover a portion of or the entire limbal area of the eye when the finished contact lens is inserted into the eye. The mold is then filled with a monomer or other polymerizable substance, which is then polymerized. The colorant which had become swollen in the monomer is embedded into the finished contact lens.

The contact lens mold utilized in this invention has only one finished surface, which will form an exterior surface of the finished lens. This exterior surface may either be the front of the contact lens or the base, depending on the type of contact lens mold utilized. The side opposite to the finished surface of the molded side is formed by machining or lathing the unfinished portions of the casting.

### BRIEF DESCRIPTION OF THE DRAWINGS

FIG. 1 illustrates a one-sided mold with a colorant applied in accordance with the present invention;

FIG. 2 illustrates a one-sided mold used in conjunction with an unfinished casting surface in accordance with the present invention;

FIG. 3 illustrates a one-sided mold containing a polymerized material after the unmolded surface has been machined; and

FIG. 4 illustrates a side view and a top view of a contact lens formed in accordance with the present invention.

### DETAILED DESCRIPTION OF AN EMBODIMENT OF THE INVENTION

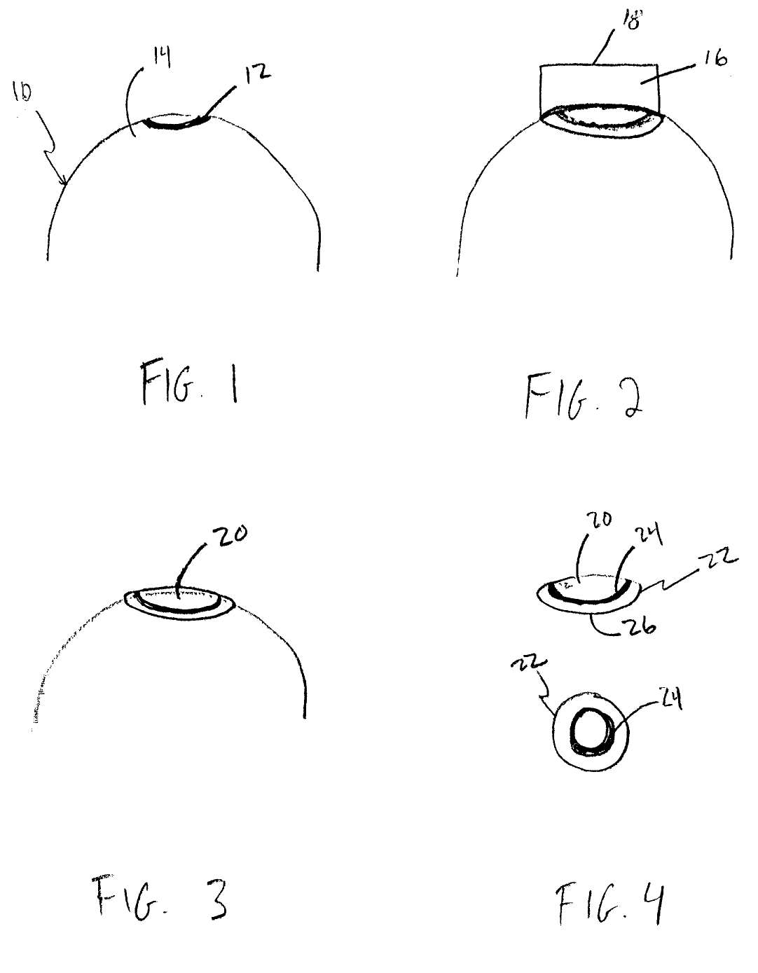

The method of forming a contact lens in accordance with the present invention and product made thereby, is described herein and illustrated in the accompanying FIGS. 1 through 4.

FIG. 1 shows a one-sided contact lens mold 10 utilized in the manufacture of contact lenses. Although the half of the mold shown in FIG. 1 is used to form the base side of a contact lens (i.e., the side of the contact lens that makes contact with the wearer's eye), it can be easily understood that the half of a one-sided contact lens mold used to form the front side of a contact lens (i.e., the side of the contact lens that does not make contact with the wearer's eye), could also be used in the manufacture of a contact lens in accordance with the present invention.

In order to form the contact lens containing a limbal ring pattern, a colorant 12 is initially printed on to the surface 14 of the one-sided contact lens mold 10. The colorant 12 is applied in a pattern on the mold such that when the finished contact lens is placed on the eye, the colorant 12 will be positioned to cover a portion of or all of the limbus area of the eye, the area between the iris and the sclera. A description of the limbal area and the placement of the colorant necessary to cover the limbus area can be found in U.S. Pat. No. 5,414,477 to Jahnke, and U.S. Pat. Nos. 5,160,463 and 5,302,978 to Evans. The pattern may be made up of a solid line of colorant, concentric circles of colorant, or dots of colorant of uniform or varying shapes and sizes. Depending on the type of contact lens mold utilized, the colorant may be applied to the base or the front of the contact lens.

The colorant may be selected from a wide variety available for coloring contact lenses including pigments, vat dyes, reactive dyes, and conventional soluble dyes, among others. The different applications of these colorants to a mold are known to one having ordinary skill in the art.

A preferred method of printing a colorant to the surface of a one-sided contact lens mold is to suspend a mixture of pigments in a polymer dissolved in solvent. The mixture is applied to the surface of the mold by transfer pad printing. As shown in FIG. 1, this mixture would be applied to the surface 14 of the one-sided contact lens mold 10 in a limbal pattern. Methods of printing colorant on a contact lens have been described in U.S. Pat. Nos. 4,582,402; 4,704,017 and 4,720,188 to Knapp and U.S. Pat. Nos. 5,034,166; 5,116,112; and 5,120,121 to Rawlings et al.

As shown in FIG. 2, once the colorant 12 has been printed to the surface 14 of the one-sided contact lens mold 10, a polymerizable material 16, such as a monomer, is placed in the mold on top of the limbal ring colorant 12. The colorant becomes swollen in the monomer. The monomer 16 is casted or polymerized as understood by one having ordinary skill in the art, thereby creating a molded surface 14 on one side of the contact lens (in this example, the base side of the contact lens is the mold finished side). The polymerization process also results in an unfinished casting surface 18 on the side of the polymerized material opposite to the mold finished side.

After polymerization of the monomer material 16, the one-sided contact lens mold 10 containing the polymerized material, is mounted on a lathe (not shown), and the polymerized material is machined or lathed to specification resulting in a polymerized material with a machine finished surface 20 on the side opposite to the mold finished surface, as shown in FIG. 3. FIG. 4 shows the resulting contact lens 22 after removal from the one-sided contact lens mold 10. The contact lens 22 contains a limbal ring pattern 24, with one surface 20 of the contact lens 22 machined, and the other surface 26 of the contact lens 22 mold finished.

An alternative embodiment to the printing method described above would include applying an initial amount of monomer or polymerizable material to the surface of the one sided contact lens mold. Then, the colorant material is applied to the polymerizable material in the limbal ring pattern as described above. The combination of the initial polymerizable material and the colorant material may be casted either after the application of the polymerizable material, after the application of the colorant material, after the application of each material, or no casting need be done to the combination. After the colorant material has been printed on to the one sided contact lens mold, the contact lens can be finished as described above.

Another alternative embodiment to the present invention would utilize a one-sided mold that would form a mold finished surface on the front side, instead of the mold shown in the figures and described above. In the alternative embodiment, the limbal ring colorant would again be applied to the molded finished surface; however, the molded surface would be on the front side while the machined or lathed surface would be on the base, opposite to that shown in the preferred embodiment.

The above description and drawings of the present invention are intended to illustrate, but not limit the present invention, which is defined in the claims. Numerous variations from the above description, still in accordance with the present invention, may be possible.

What is claimed is:

1. A method of forming a contact lens with a colored ring covering a substantial portion of the entire limbal region of the eye when the contact lens is worn, comprising the steps of:
printing a colorant material in a limbal ring pattern to a surface of a one-sided contact lens mold;
filling said one-sided contact lens mold with a polymerizable substance such that said substance comes in contact with said colorant and said one-sided contact lens mold;
casting the polymerizable substance, thereby forming a mold finished surface of a contact lens containing a limbal ring pattern which will cover a substantial portion of the entire limbal region of the eye when the contact lens is worn, and an unfinished surface on the side opposite the mold finished surface; and
machining the side opposite the mold finished surface to form a machined finished side to the contact lens.

2. The method of forming a contact lens in claim 1, wherein the step of printing said colorant in a limbal ring pattern to a surface of a one-sided contact lens mold comprises the steps of:
applying a colorant material to the surface of the one sided contact lens mold.

3. The method of forming a contact lens in claim 1, wherein the step of printing said colorant in a limbal ring pattern to a surface of a one-sided contact lens mold comprises the steps of:
applying an initial polymerizable substance to the surface of the one sided contact lens mold;
applying a colorant material to said initial polymerizable substance.

4. The method of forming a contact lens in claim 3, further comprising the step of casting a combination of said initial polymerizable substance and said colorant material.

5. The method of forming a contact lens in claim 3, further comprising the step of casting said initial polymerizable substance prior to applying said colorant material.

6. The method of forming a contact lens in claim 5, further comprising the step of casting a combination of said initial polymerizable substance and said colorant material.

7. The method of forming a contact lens in claim 1, wherein the step of printing said colorant in a limbal ring pattern to a surface of a one-sided contact lens mold comprises the steps of:
suspending a mixture of pigments in a polymer dissolved in solvent; and
applying said mixture to said surface of the one-sided contact lens mold by transfer pad printing.

8. The method of forming a contact lens in claim 1, wherein the colorant material comprises one selected from the group consisting of pigments, vat dyes, reactive dyes and conventional soluble dyes.

9. The method of forming a contact lens in claim 1, wherein the step of machining said machine finished side comprises lathing said machine finished side.

10. The method of forming a contact lens in claim 1, wherein the one-sided contact lens mold is the side of the mold that forms the base side of the contact lens.

11. The method of forming a contact lens in claim 1, wherein the one-sided contact lens mold is the side of the mold that forms the front side of the contact lens.

12. The method of forming a contact lens in claim 1, wherein the limbal ring pattern comprises a solid line of colorant on the area of the contact lens that covers a portion of or the entire limbal region of the eye.

13. The method of forming a contact lens in claim 1, wherein the limbal ring pattern comprises a group of concentric circles of colorant on the area of the contact lens that covers a portion of or the entire limbal region of the eye.

14. The method of forming a contact lens in claim 1, wherein the limbal ring pattern comprises a group of dots of colorant on the area of the contact lens that covers a portion of or the entire limbal region of the eye.

15. The method of forming a contact lens in claim 14, wherein the group of dots of colorant comprises dots of any shape, such as round, square, hexagonal or elongated.

16. The product made by the method of any of claims 1, 2, 3, 4, 5, 6, 7, 8, 9, 10, 11, 12, 13, 14 or 15.
